(19) United States
(12) Patent Application Publication
(10) Pub. No.: US 2004/0017358 A1
(43) Pub. Date: Jan. 29, 2004

(54) Housing assembly for computer mouse

(76) Inventor: Hsiao Ming Kuo, Taipei (TW)

Correspondence Address: FULBRIGHT AND JAWORSKI L L P, PATENT DOCKETING 29TH FLOOR, 865 SOUTH FIGUEROA STREET, LOS ANGELES, CA, 900172576

(21) Appl. No.: 10/621,057

(22) Filed: Jul. 16, 2003

(30) Foreign Application Priority Data
Jul. 19, 2002 (TW) 91211029

(51) Int. Cl. G09G 5/08

(52) U.S. Cl. 345/163

(57) ABSTRACT

A housing assembly for a wireless computer mouse is provided, including: a base; a housing coupled to the base to form a space for receiving electronic components for the mouse, and further having a battery compartment for receiving batteries as a power source to the mouse and a locking portion; and a cover having at least a front piece, an actuating piece, and a rear piece which are coupled atop to the housing respectively, wherein the rear piece has a locking member locked with the locking portion of the housing, and the actuating piece has an actuating member such that when the actuating piece is downwardly pushed, the actuating member can release the locking state between the locking portion of the housing and the locking member of the rear piece, and the rear piece is detached from the housing to expose the battery compartment for replacement of the batteries.

### FIELD OF THE INVENTION

The present invention relates to housing assemblies for computer mice, and more particularly, to a housing assembly for a wireless mouse, whose cover can be easily detached from a housing thereof to facilitate easy replacement of batteries.

### BACKGROUND OF THE INVENTION

A mouse is usually an Spatial component in association with a computer and used for controlling and moving a cursor on a computer screen to perform desirable operations. A wired mouse is connected with the computer by signal transmission wires. The wired mouse operates to send an input signal to a mainframe of the computer where the input signal is processed and then outputted to the screen to indicate the corresponding operation being done. However, such a wired mouse in use renders a significant drawback that the signal transmission wires may impede or limit the movement of the mouse. To overcome this drawback, a wireless mouse not requiring signal transmission wires is developed.

The wireless mouse is installed with a plurality of wireless electronic components such as transmitting/receiving antenna, carrier wave generator, antenna driver amplifier, detector, comparator, and decoder, which are mounted on a circuit substrate and received in the mouse. The antenna is used to transmit wireless signals from the mouse to the computer to control operations of the cursor.

A power source to the above wireless mouse is commonly one or more batteries received in the mouse and provides power for the mouse for signal transmission. When the batteries are exhausted and Deeds to be replaced, the mouse must be disassembled to expose the batteries for replacement and also the electronic components in the mouse, which is usually achieved by unscrewing screws that connect a cover and a h using of the mouse together. A significant drawback of doing so is that disassembly of the mouse may lead Lo damage to the electronic components upon being exposed. Moreover, the unscrewing operation is usually time-ineffective, and once the mouse is disassembled to expose the electronic components, a user who is replacing the batteries may be subject to a risk of touching the electronic components and hurt.

Therefore, the problem to be solved herein is to provide a housing assembly for a computer mouse that can solve the above prior-art drawbacks to facilitate battery replacement, avoid damage to electronic components received in the mouse as well as ensure the safety of performing the battery replacement.

### SUMMARY OF THE INVENTION

An objective of the present invention is to provide a housing assembly for a computer mouse, having a housing mounted with an actuating piece and a rear piece, whereby the actuating piece can be pressed to detach the rear piece from the housing to expose batteries received in the housing and thereby facilitate battery replacement.

Another objective of the present invention is to provide a housing assembly for a computer mouse, having a housing mounted with an actuating piece and a rear piece, whereby the actuating piece can be pressed to detach the rear piece from the housing for battery replacement without exposing electronic components received in the mouse, thereby not damaging the electronic components, and also ensuring the safety of performing the battery replacement.

In accordance with the above and other objectives, the present invention proposes a housing assembly for a computer mouse, comprising: a base, a housing adapted to be coupled to the base from the bottom of the housing so as to form a space in-between for receiving electronic components required for the computer mouse, the housing being formed with a battery compartment for receiving at least one battery as a power source to the computer mouse and a locking portion; and a cover formed with at least a front piece, an actuating piece, and a rear piece which are coupled atop to the housing respectively, wherein the rear piece is formed with a locking member for being locked with the locking portion of the housing and wherein the actuating piece is provided with an actuating member such that when the actuating piece is downwardly pushed by an external force, the actuating member is capable of releasing the locking state between the locking portion of the housing and the locking member of the rear piece, and the rear piece is detached from the housing to expose the battery compartment for replacement of the battery.

### BRIEF DESCRIPTION OF THE DRAWINGS

The present invention can be more fully understood by reading the following detailed description of the preferred embodiments, with reference made to the accompanying drawings, wherein:

FIG. 1 is an exploded view of a housing assembly for a computer mouse according to the invention;

FIG. 2 is a top view of the housing assembly for a computer mouse according to the invention; and

FIG. 3 is a schematic diagram showing operative conditions in the use of the housing assembly for a computer mouse according to the invention.

### DETAILED DESCRIPTION OF THE PREFERRED EMBODIMENT

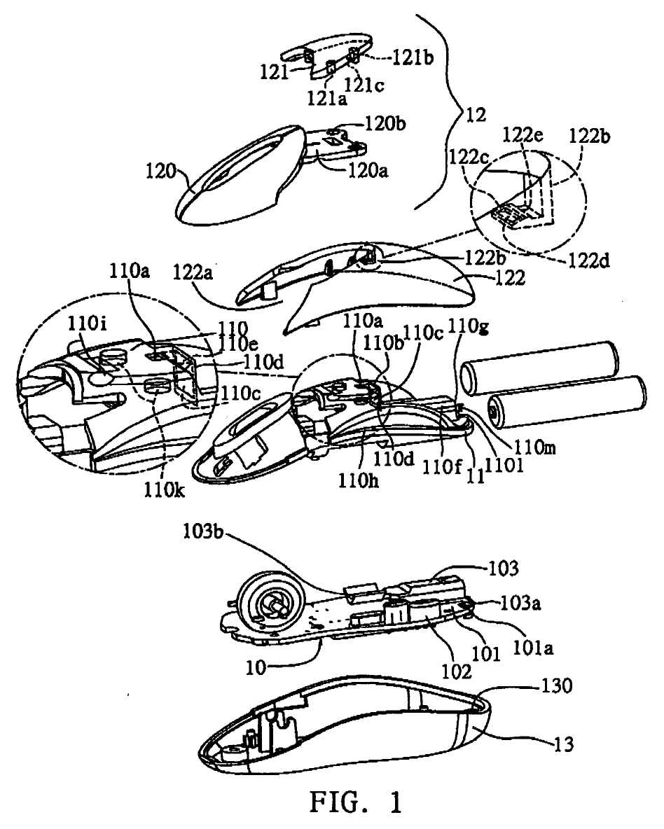

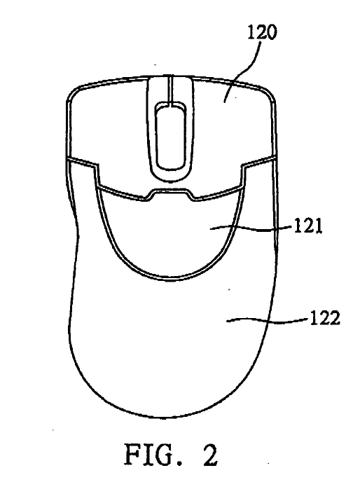

As shown in FIGS. 1 and 2, a housing assembly for a computer mouse proposed by the present invention comprises: a housing 11, a cover 12 coupled atop to the housing 11, and a base 13 coupled to the bottom of the housing 11. The housing 11 and the base 13 form a space in-between for receiving an internal circuitry device 10. A locking portion 110 is formed at the center of the housing 11, comprising a locking hole 110a formed atop and a side coupling hole 110c associated with a downward awl-shaped protrusion 110e. The cover 12 comprises a front piece 120, an actuating piece 121, and a rear piece 122. The front piece 120 is mounted at a front end of the housing 11. The actuating piece 121 is coupled to the locking hole 110a of the housing 11 and has an actuating member 121b formed on the bottom thereof. The rear piece 122 is connected with the coupling hole 110c of the housing 11 and has a locking member 122b formed at one end thereof.

The internal circuitry device 10 is connected with the bottom of the housing 11 and comprises a printed circuit board (PCB) 101 on which electronic components 102 for wireless signal transmission are mounted. The PCB 101 is formed with a through hole at one end thereof, allowing a screw 110m to be inserted through the through hole of the PCB 101 and a hole 1101 at one end of the housing 11 and into a threaded mount 130 on the base 13, such that the housing 11, the internal circuitry device 10 and the base 13 are interconnected as a whole.

The locking portion 110 formed at the center of the housing 11 comprises the locking hole 110a and a frame-shaped structure 110d. The coupling hole 110c is formed at one side of the frame-shaped structure 110d, and the downward awl-shaped protrusion 110e is formed inwardly from an inner top surface of the frame-shaped structure 110d. The bottom of the frame-shaped structure 110d is connected to a protruded portion 110f formed on a middle area of the bottom of the housing 11. A battery compartment 110g is located along two relatively longer sides of the protruded portion 110f for receiving batteries which provide power to allow the internal circuitry device 10 to generate and output signals. Moreover, a slide slot 110h is formed on each of two relatively longer edge sides of the housing 11 and used to guide the rear piece 122 to be mounted on the housing 11. The rear piece 122 is formed with a recessed portion 122a directed toward the center thereof, and the locking member 122b extends downwardly from the edge center of the recessed portion 122a. The locking member 122b is bent at a bottom end thereof to form a horizontally extending portion 122c that is formed with a slant surface having a groove 122d at a free end of the horizontally extending portion 122c and a protruded block 122e on a top surface of the horizontally extending portion 122c, wherein the protruded block 122e is located adjacent to the groove 122d and forms a recessed space in-between with the locking member 122b. When the rear piece 122 is coupled to the housing 11 via the slide slots 110h, the locking member 122b of the rear piece 122 is inserted into the coupling hole 110c of the housing 11, and the recessed space between the protruded block 122e and the locking member 122b is engaged with the downward awl-shaped protrusion 110c of the housing 11, to thereby provide a locking effect to interconnect the rear piece 122 and the housing 11.

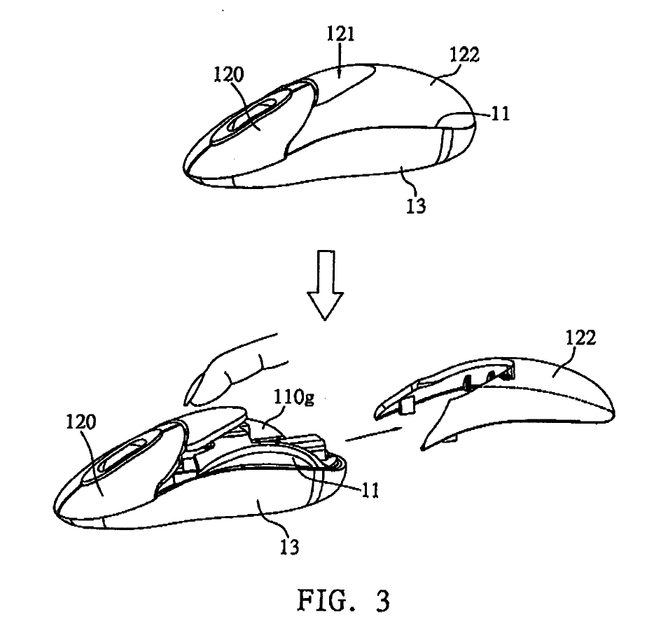

The actuating piece 121 is engaged with the recessed portion 122a of the rear piece 122 to entirely cover the locking portion 110 of the housing 11. The actuating piece 121 has one or more pillars 121a (two shown in the drawing) protruding from the bottom thereof each corresponding to a hole 110i on the locking portion 110 of the housing 11, such that the pillars 121a can be inserted into the holes 110i to firmly attach the actuating piece 121 to the locking portion 110 of the housing 11. The actuating portion 121b of the actuating piece 121 corresponds in position to the locking hole 110a of the locking portion 110 and has a hook 121c directed toward the front piece 120. The actuating portion 121b is adapted to be engaged with the locking hole 110a to thereby provide a locking effect between the actuating piece 121 and the housing 11. In operation, as shown in FIG. 3, the pillars 121a act as pivots, and a user downwardly presses the part of the actuating piece 121 having the actuating portion 121b, such that the actuating portion 121b would be pushed downwardly beyond the locking hole 110a, making the hook 121c pressed on the groove 122d at the horizontally extending portion 122c of the locking member 122b of the rear piece 122. As a result, the horizontally extending portion 122c of the locking member 122b would be deformed downwardly to thereby release the engagement between the protruded block 122e on the horizontally extending portion 122c and the downward awl-shaped protrusion 110e of the housing 11, such that the rear piece 122 is detached from the locking portion 110 of the housing 11, and the battery compartment 110g within the housing 11 is exposed for replacing the batteries, thereby making the battery replacement easy and time-effective to implement.

Further referring to FIG. 1, the protruded portion 110f formed on the housing 11 is internally formed with a cavity (not shown) for accommodating a protective cover 103. The protective cover 103 has at least one coupling member 103a on the bottom thereof, and the coupling member 103a can be inserted into a corresponding slot 101a formed on the PCB 101 to connect the protective cover 103 with the PCB 101. The protective cover 103 is used to cover and protect the delicate and fragile electronic components 102 disposed on the PCB 101. The protective cover 103 further has an extending cover 103b for protecting a chip (not shown) mounted on the PCB 101 corresponding in position to the locking portion 110 of the housing 11. The protective cover 103 and the extending cover 103b protect the electronic components 102 and chip from being damaged during the operation of releasing or detaching the rear piece 122 from the housing 11.

The locking portion 110 of the housing 11 further comprises at least one coupling pillar 110k on the bottom thereof and corresponding in position to at least one hole 120b formed on an insertion member 120a of the front piece 120. The front piece 120 can be firmly connected with the housing 11 by inserting the insertion member 120a into the locking portion 110 and engaging the hole 120b with the coupling pillar 110k.

In the use of the above housing assembly for a computer mouse according to the invention, as shown in FIG. 3, the user can replace batteries for the mouse simply by downwardly pressing the actuating piece 121 to release the locking between the rear piece 122 and the housing 11 or detach the rear piece 122 from the housing 11, such that the battery compartment 110g where the batteries are received is exposed, making the user easily replace the exhausted batteries with new batteries. Then, the rear piece 122 can be mounted back on and coupled to the housing 11. During the above operation, referring to FIG. 1, the inner circuitry device 10 is disposed between the housing 11 and the base 13 and its electronic components 12 are protected by the protective cover 103 without being exposed or subject to undesirable damage, thereby not affecting the lifetime and operative performances of the mouse, and also ensuring the safety for the user to operate the mouse and replace the batteries.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A housing assembly of a computer mouse, comprising:
a base;
a housing adapted to be coupled to the base from the bottom of the housing so as to form a space in-between for receiving electronic components required for tile computer mouse, the housing being formed with a battery compartment for receiving at least one battery as a power source 10 the computer mouse and a locking portion, and
a cover formed with at least a front piece, an actuating piece, and a rear piece which am coupled atop to the housing respectively, wherein the rear piece is formed with a locking member for being locked with the locking portion of the housing and wherein the actuating piece is provided with an actuating member such that when the actuating piece is downwardly pushed by an external force, the actuating member is capable of releasing the locking state between the locking portion of the housing and the locking member of the rear piece, and the rear piece is detached from the housing to expose the battery compartment for replacement of the battery.

2. The housing assembly of claim 1, wherein the locking portion of the housing is formed with a locking hole, a coupling hole, and a downward protrusion associated with the coupling hole.

3. The housing assembly of claim 2, wherein the actuating member of the actuating piece is inserted into the locking hole of the locking portion of the housing for connecting the actuating piece with the housing.

4. The housing assembly of claim 3, wherein the locking member of the rear piece is coupled to the coupling bole of the locking portion of the housing and formed at an end thereof with an extending portion that is adapted to be engaged with the downward protrusion of the housing to lock the locking portion of the housing with the locking member of the rear piece.

5. The housing assembly of claim 4, wherein the extending portion of the locking member, coupled to the coupling hole of the housing, is formed with a groove at an end thereof corresponding in position to the actuating member of the actuating piece inserted into the locking hole of the housing.

6. The housing assembly of claim 5, wherein when the actuating piece is downwardly pushed by the external force, the actuating member of the actuating piece is moved downwardly through the locking hole to press on the groove of the locking member of the rear piece, so as to deform the extending portion of the locking member and release the engagement between the extending portion and the downward protrusion of the housing, thereby making the locking member of the rear piece detached from the locking portion of the housing.

7. The housing assembly of claim 1, wherein the housing further comprises a protruded portion connected with the locking portion, the protruded portion covering the space where the electronic components are received to prevent the electronic components from being exposed.

8. The housing assembly of claim 1, wherein the front piece has at least one hole that is coupled to at least one coupling pillar formed on the housing to thereby connect the front piece with the housing.

9. The housing assembly of claim 1, wherein the actuating piece further comprises at least one pillar that is coupled to at least one hole formed in the locking portion of the housing for attaching the actuating piece to the housing.
